(19) United States
(12) Patent Application Publication
(10) Pub. No.: US 2026/0211540 A1
(43) Pub. Date: Jul. 23, 2026

(54) SYSTEM AND METHOD FOR RECOMMENDED ACTION GENERATION AND EXECUTION

(71) Applicant: Salesforce, Inc., San Francisco, CA (US)

(72) Inventors: Alan WEIBEL, Reno, NV (US); Tommy DALE, JR., San Diego, CA (US); Yon Aran RHEE, Dunedin (NZ); Cong NIU, San Mateo, CA (US); Austin Richard GUEVARA, Indianapolis, IN (US)

(73) Assignee: Salesforce, Inc., San Francisco, CA (US)

(21) Appl. No.: 19/030,205

(22) Filed: Jan. 17, 2025

(51) Int. Cl. G06F 3/04842; G06F 3/0482

(52) U.S. Cl. CPC G06F 3/04842; G06F 3/0482

(57) ABSTRACT

Disclosed herein are system, method, and computer program product aspects for automatically generating recommended actions for a user. During operation, many different data points are examined, including user actions, calendar data, company guidelines, etc. A machine-learning model is used to analyze these data points and determine any number of recommended actions for the users. Such actions may include any known actions to be carried out in the course of the user’s business, such as following up with a customer, drafting an introductory email, submitting expense reports, etc. Once the recommended actions have been identified, they are provided to the user in a chat interface or list interface, where the user can view, select, edit, or authorize such actions. The model can then execute authorized actions as needed.

### BACKGROUND

Large Language Models (LLMs) are machine learning (ML) models that can comprehend and generate human language text and other generative outputs based on a large data training set. LLMs are starting to become integrated into a wide variety of fields, such as research, agent response, healthcare, translation, content creation, and a wide array of business applications.

In order to cause an LLM to produce responsive action, it is often necessary to write a prompt to the LLM. This prompt is essentially an instruction to the LLM. Different LLMs may use different prompts, and one prompt may not necessarily be interchangeable with another. This has given rise to new professions, such as prompt engineer, who may be a primary resource for prompting LLMs to generate desired responses.

One or more aspects of the present disclosure relate to the field of machine learning (ML) models, and more specifically to a selecting a specific ML model for proactively analyzing a user’s circumstances without prompting, and providing proposed actions to the user without a specific request from the user.

### BRIEF DESCRIPTION OF THE DRAWINGS

The accompanying drawings are incorporated herein and form a part of the specification.

FIG. 1 illustrates a block diagram of an exemplary proactive copilot environment, according to aspects of the present disclosure.

FIG. 2 illustrates a block diagram of an exemplary proactive copilot system for use in the proactive copilot environment according to aspects of the present disclosure.

FIG. 3 illustrates a block diagram of an exemplary AI for use in the proactive copilot system according to aspects of the disclosure.

FIGS. 4A-4C illustrate user interfaces for use with the proactive copilot system according to aspects of the present disclosure.

FIG. 5 illustrates a flowchart diagram of a proactive copilot method according to aspects of the present disclosure.

FIG. 6 illustrates an exemplary user interface for use with proactive copilot method according to aspects of the present disclosure.

FIG. 7 illustrates a user interface for configuring the proactive copilot system according to aspects of the present disclosure.

FIG. 8 illustrates a block diagram of an exemplary computer system according to aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product aspects, and/or combinations and sub-combinations thereof, for using a proactive copilot system to automatically, and without user input, predict and carry out assistive actions on behalf of a user.

Many different business computer environments, and in particular those that serve customer or subscriber needs, may include one or more machine learning (ML) models that can be used by customers to carry out various tasks. For example, a customer sales environment may be used by subscribers to track sales team statistics, as well as account information of their customers. Such account information may include information relating to a sales individual or sales team, including volume or dollars sold, number of accounts being handled, and customer business and contact information, and sales targets. Meanwhile, the account information may further include information relating to the different accounts, such as customer business information, primary contacts, pending accounts, account targets etc. In such an environment, machine learning models may be made available to the subscribers in order to assist them with their various business tasks. In aspects, such tasks may include a wide range of requests, from something as fundamental as making a request for information (e.g., “what is the contact information of the primary point of contact at Company A?”) to something that far more complex (e.g., “For all accounts currently assigned to Salesperson A, generate a spreadsheet showing percentages of sales to those accounts over the various products purchased by those accounts.”).

Notably, while there has been significant movement in the business industry toward the use of LLMs in their day-to-day operations, most companies are very limited in their usage of them. Namely, most AI usage requires a specific request be provided to model, usually in the form of a prompt. Depending on the company, specific individuals may be required to generate these prompts in order to ensure appropriate output by the model. This greatly limits the usability of these models, as a user would need to identify a task or request important enough to justify requesting action from an AI prompt engineer. Therefore, there is a need in the industry for an AI system that can monitor a user’s actions and data, and proactively generate recommended tasks. There is also a need in the industry for a system that can automatically carry out recommended actions.

In aspects of the present disclosure, various actions and other data relating to a particular user and/or company associated with the user are monitored by an AI or rules model. In embodiments, an administrator can configure a set of triggers to be monitored for a given action. The AI analyzes the monitored data, together with known data relating to the user or company, and determines one or more recommended actions for the user. These recommended actions are then provided to the user. In an embodiment, the AI generates a user interface, or aspects thereof, for delivering the recommended actions to the user.

In other aspects of the present disclosure, the user receives the recommended actions from the AI in a user interface. The interface includes certain buttons or other actionable objects that allow the user to select one of certain responses to a proposed recommended action, such as authorizing the AI to carry out the recommended action. Once authorized, the AI then performs the recommended action and outputs a result of the recommended action to the user.

To provide an example, the AI may identify based on the user’s calendar that the user has an upcoming meeting. In response, the AI identifies a plurality of recommended actions that include providing the user with a summary of the subject matter associated with the meeting, or links to meeting-related documents, or a summary of the contact involved in the meeting. These are provided to the user through a UI, where the user can authorize, decline, or revise a selected action.

In embodiments, the system provides capabilities for defining criteria that triggers a recommended action. In embodiments, these capabilities are provided through a visual user interface that allows the user to configure these triggers with minimal or no coding. These and other aspects of the present disclosure will not be described below relative to the corresponding drawings.

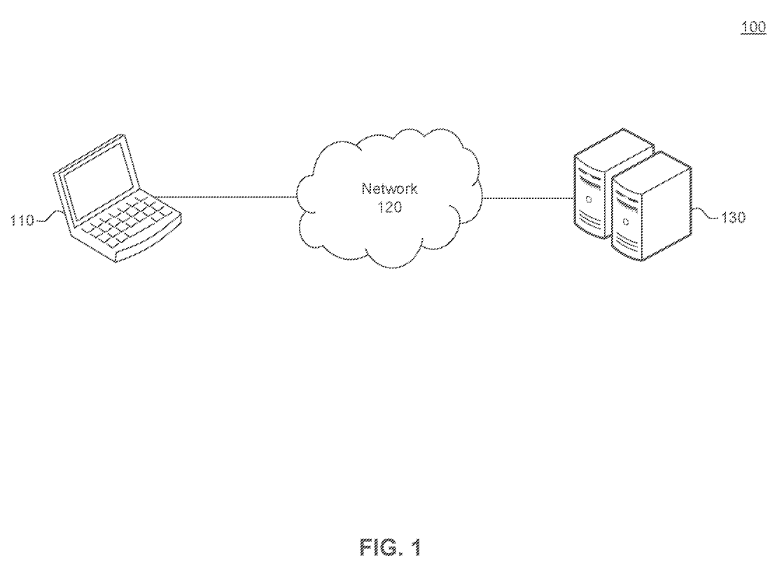

FIG. 1 illustrates a block diagram of an exemplary proactive copilot environment 100, according to aspects of the present disclosure. As shown in FIG. 1, a user device 110 such a personal computer, communicates with the proactive copilot system 130 via network 120. In embodiments, the user device 110 may take the form of a mobile device, personal computer 120, or other electronics device capable of communicating over a network, such as a smartphone, tablet computer, personal digital assistant, smartwatch, etc. In aspects, the host system 170 may include all interfaces and functionality in support of the subscriber, as well as internal systems. Included within the host system 170 is an LLM selection system 175.

As shown in FIG. 1, the user device 110 connects to the proactive copilot system 130 over a network 120. In aspects, network 150 may be any type of computer or telecommunications network capable of communicating data, including but not limited to a local area network, a wide-area network (e.g., the Internet), or any combination thereof. The network may include wired and/or wireless segments. In some aspects, network 120 may be a secure network. In some aspects, the user device 110 or the proactive copilot system 130 may reside within network 120.

In operation, a user of user device 110 has their data and activities monitored by the proactive copilot system 130. Namely, as the user performs actions and/or updates certain databases, the proactive copilot system 130 detects these actions and/or changes and analyzes them for potential recommended actions. To provide an example, the user may update their calendar to include a meeting with a particular client. By monitoring this change, the proactive copilot system 130 may determine that an action of summarizing the client and its key executives is recommended prior to the call. Other actions by the user and/or other monitored data by the proactive copilot system 130 may cause other recommended actions to be generated. These and other aspects will be discussed in further detail below.

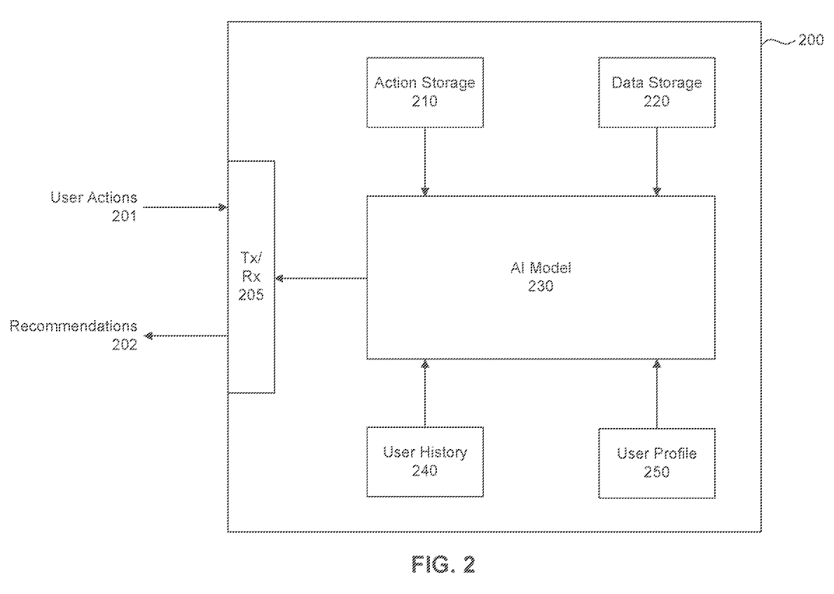

FIG. 2 illustrates a block diagram of an exemplary proactive copilot system 200 for use in the proactive copilot environment 100 according to aspects of the present disclosure. As shown in FIG. 2, the proactive copilot system 200 includes a transceiver 205, several different data storages, including but not limited to action storage 210, data storage 220, user history 240, and user profile 250, and an artificial intelligence block 230, and may represent an exemplary embodiment of the proactive copilot system 130 of FIG. 1.

As shown in FIG. 2, the transceiver 205 communicates with the user device 110 over the network. In embodiments, the transceiver 205 includes a communication interface capable of communicating using one or more communication protocols associated with the network 120. Using this interface, the transceiver 205 receives user actions 201 and other data from the user device. This data is stored for later analysis associated with the user. For example, as shown in FIG. 2, action storage 210 may store actions taken by the user, such as the user scheduling an appointment, creating a new customer entry, updating a sale status, sending an email, receiving a telephone call, etc. Data storage 220 may store data of a more static nature, such as customer data, past events, configured actions, etc. User history may store prior actions taken by the user, including not only unilateral actions taken by the user, but also actions taken in response to recommended actions, such as which actions were authorized, declined, and/or modified, and how any modifications were made. User profile includes data pertaining to personal information of the user, such as the user’s experience level, rank within the company, known associates, etc. In various embodiments, the data of the action storage 210, data storage 220, user history 240, and user profile 250 may be stored in a single data repository, either within the proactive copilot system 200 or on one or more remote databases, such as a network attached storage, server, or other remote storage device capable of being accessed via the network 120 or other communication protocol.

In embodiments, the AI 230 receives all the relevant data from the associated data storage blocks, and performs an analysis thereon to determine whether any new or updated recommendation actions should be provided to the user, which is discussed in further detail below. Once the AI 230 identifies new recommended actions, the AI 230 provides the recommended actions 202 to the user via the transceiver 205 for further action. Depending on the user’s response, the AI 230 can carry out, cancel, or modify the recommended action, as discussed in further detail below.

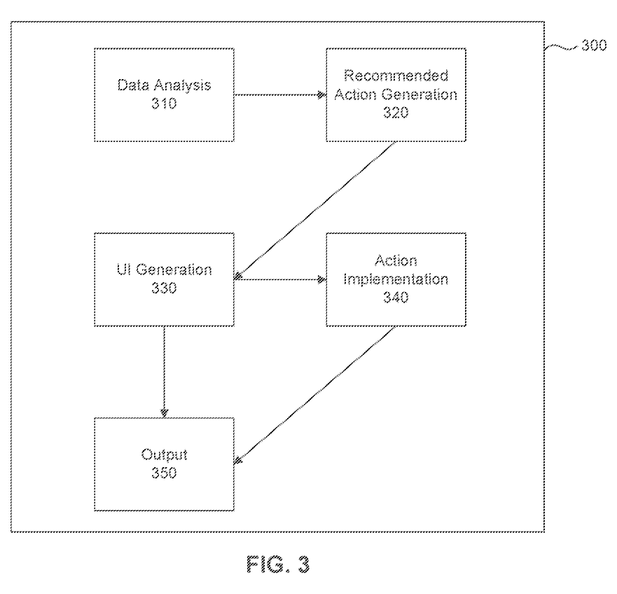

FIG. 3 illustrates a block diagram of an exemplary AI 300 for use in the proactive copilot system 200 according to aspects of the disclosure. As shown in FIG. 3, the AI 300 includes a data analysis block 310, a recommended action generation block 320, a UI generation block 330, an action implementation block 340, and an output block 350, and may represent an exemplary embodiment of the AI 230 shown in FIG. 2.

In the data analysis block 310, the AI 300 examines the available data relating to the user. In embodiments, this analysis includes providing the available data to an AI model that can identify patterns or signposts in the available data. Based on the analysis of the data analysis block 310, the AI 300 generates recommended actions using the recommended action generation block 320. In embodiments, the recommended actions can be generated based on a comparison of the circumstances of the analyzed data to previous actions taken in response to similar situations. The recommended action generation block 320 provides the recommended actions to the UI generation 330.

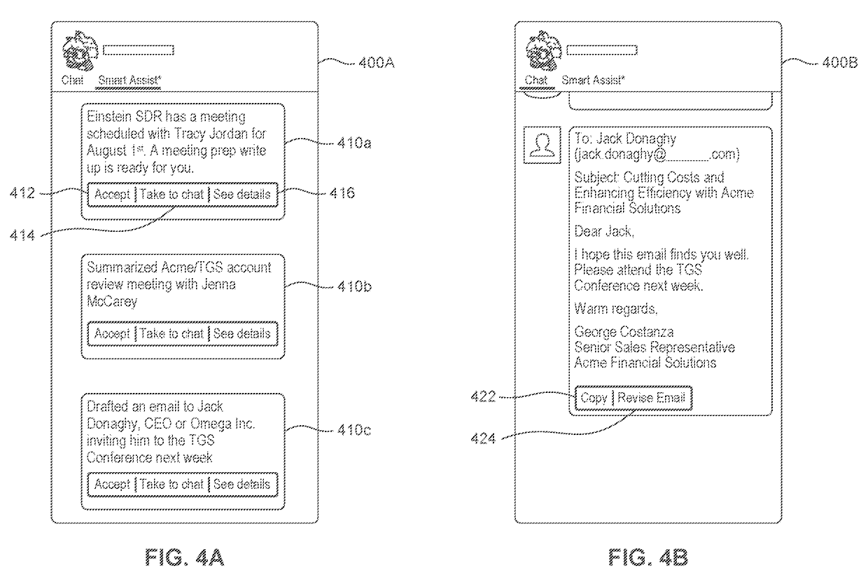

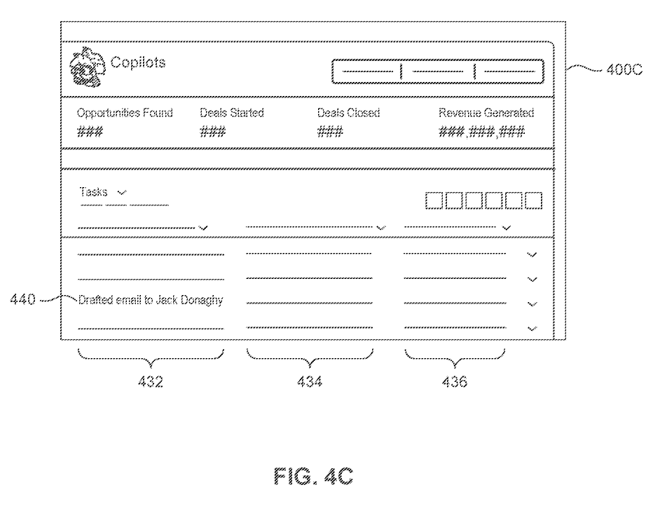

The UI generation 330 is responsible for generating a visual user interface that is user-facing, and that includes representations of one or more of the recommended actions. In embodiments, this can take the form of a chat window or chat sidebar through which the user is capable of sending chat messages to the AI or other individuals. Within that window, one or more of the recommended actions are shown to the user at relevant times, with each being provided together with a plurality of response options, such as “Accept,” “Take to Chat,” or “See details,” as shown for example in FIG. 4.

FIG. 4A illustrates a user interface 400A for use with the proactive copilot system according to aspects of the present disclosure. As shown in FIG. 4A, the chat window interface 400A includes a plurality of recommended actions 410a-c, each of which includes a brief summary of the action to be taken. For example, action 410a describes that “Einstein SDR has a meeting scheduled with Tracy Joran for August 1^{st}. A meeting prep write up is ready for you.” Within this recommendation are three buttons: an “accept” button 412, a “Take to chat” button 414, and a “See details” button 416. In this example, the “accept” button 412 causes the action to be taken. In the case of action 410a, the AI will generate the meeting prep write up in response to the user selecting the “Accept” button. Selecting the “Take to chat” button 414, on the other hand, allows the user to edit the response in the chat window. For example, the user can modify the request in chat to ask for specific details, such as generating the meeting prep with a particular emphasis, topic details, or length. When carrying out the action, the AI will account for these requests. Finally, the “See details” button 416 causes the AI to carry out the recommended action and provide the user with a preview of the results. In this way, the user is given an opportunity to review the results of the action and make modifications thereto.

Returning to FIG. 3, based on a response from the user (e.g., such as in response to the user selecting the “Accept” or “See details” action, or providing a custom request in the “Take to chat” action), the AI 300 will use the action implementation block 340 to perform the recommended action or modified action. In various examples, the action implementation block 340 can perform any number of various actions using an AI model, such as summarizing a meeting, drafting an email, generating sales statistics, ascertaining information pertaining to a particular client, etc. Once the action has been carried out by the action implementation block 240, the result is then output to the user by output block 350. In an embodiment, the output is provided to the user in the chat window of the UI, whereas other embodiments may output the result in a separate interface.

FIG. 4B illustrates a user interface 400B for use with the proactive copilot system according to aspects of the present disclosure. The interface 400B is a chat window similar to 400A of FIG. 4A. In this example, the user has responded to recommended action 410c in FIG. 4A, which recommends drafting an email inviting a particular client to a conference, by selecting “Take the chat” within that recommendation frame. In response, the action implementation block 340 performs the recommended action, and the output block 350 provides the draft email in the chat window 400B for user review. The output block 350 includes, along with the email, a “Copy” button 422 and a “Revise email” button 424. The “Copy” button allows the user to copy the email to an email program for sending to the client, essentially allowing the user to adopt the email as their own. Meanwhile, the “Revise email” button 424 allows the user to request modifications to the email, which will cause action implementation block 340 to carry out the revision based on user instructions.

FIG. 4C illustrates a user interface 400C for use with the proactive copilot system according to aspects of the present disclosure. As discussed above, the recommendation action generation block 320 will analyze user actions and other available data to identify a plurality of recommended actions that should be provided to the user. In an embodiment, all recommended actions can be separately provided in their own user interface, such as 400C. As shown in FIG. 4C, a listing of all recommended actions may be provided to the user. In an embodiment, the AI organizes the recommended actions according to importance or urgency, such that the most important or urgent actions are positioned at the top of the list, whereas less urgent or important actions are positioned further toward to the bottom of the list.

As shown in FIG. 4C, for each recommended action, there may be several fields listed. For example, a recommended action may include a first field 432 that identifies the recommended action, a second field 434 and a third field 436. Although these fields may vary, in an example embodiment, the second field 434 may identify one or more data elements or actions that triggered the recommended action and the third field 436 may identify a due date or expiration date associated with the recommended action.

It should be understood that each of the various functional blocks of the AI 300 of FIG. 3 may be performed by one or more processors or circuits of a computing device. Additionally, the AI 300 may operate on a computing device or on a specialized AI server capable of handle computationally significant tasks consistent with the functionality described relative to the AI 300.

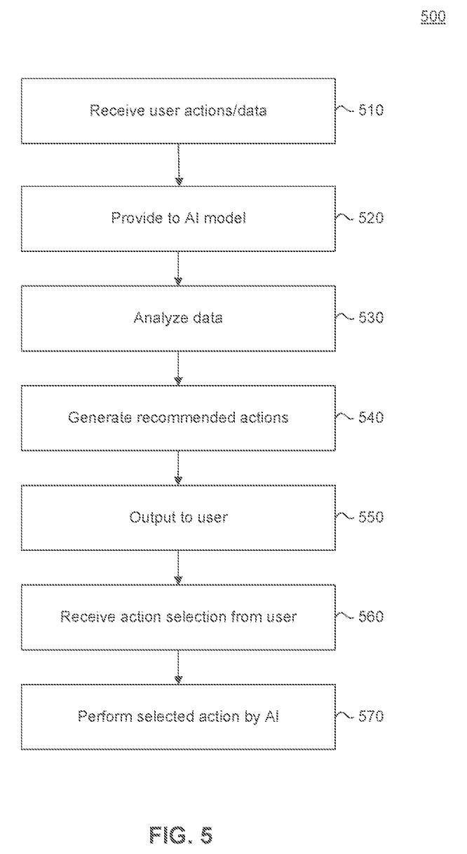

FIG. 5 illustrates a flowchart diagram of a proactive copilot method 500 according to aspects of the present disclosure. As shown in FIG. 5, the method begins in step 510 with the proactive copilot system receiving user actions and other data that may be relevant to identifying recommended actions. As discussed above with respect to FIG. 2, this data may include user actions, historical usage data by the user or others, a user profile that includes data relating to the user, such as their knowledge level, experience, background, department, etc., as well as other information, such as current events.

In step 520, the collected data is provided to the AI model. As discussed above, the AI may include one or more different models and/or algorithms capable of analyzing the received data in order to identify logical next actions to be recommended to the user. In step 530, the AI performs this analysis of the received data, which may include providing the received data to the one or more AI models.

In step 540, the AI generates the recommended actions for the user. In embodiments, the recommended actions may be generated based on the AI having been trained on historical actions and/or needs associated with different scenarios. In some embodiments, the AI may be trained on company guidelines, such as a requirement to carry out certain tasks under certain conditions (e.g., following-up with a customer within a certain period of time). For example, a meeting prep summary may be generated ahead of a meeting, a client summary may be generated ahead of a client pitch meeting, a follow-up email may be generated following a meeting or other communication with a customer, etc.

In step 550, once the recommended actions have been generated, they are output to the user in a user interface. As discussed above with respect to FIG. 4, the recommended actions can be provided to the user in a chat-style interface. Additionally, each recommended action can include certain response buttons that allow the user to select which action should be carried out, or that allow the user to modify or view the action before execution. In an alternative user interface, the recommended actions are provided in a list format, with each being arranged according to a determined importance or immediacy.

In step 560, the AI receives an action selection from the user. As discussed above, the action selection may include the user selecting a button from a displayed recommended action that triggers the execution of the recommended action. At least one such button may cause the AI to carry out the recommended action. Thus, in step 570, the AI performs the recommended action selected by the user.

In this manner, the proactive copilot system is able to proactively, and without user input or request, identify actions for recommending the user. The method also allows the user to quickly and efficiently identify and act on various tasks. It will be understood that the order of the above process steps are merely exemplary, and the steps can be rearranged in any appropriate manner, and that the process can be modified consistent with the present disclosure. Additionally, more or fewer steps may be included in the exemplary method consistent with the disclosure.

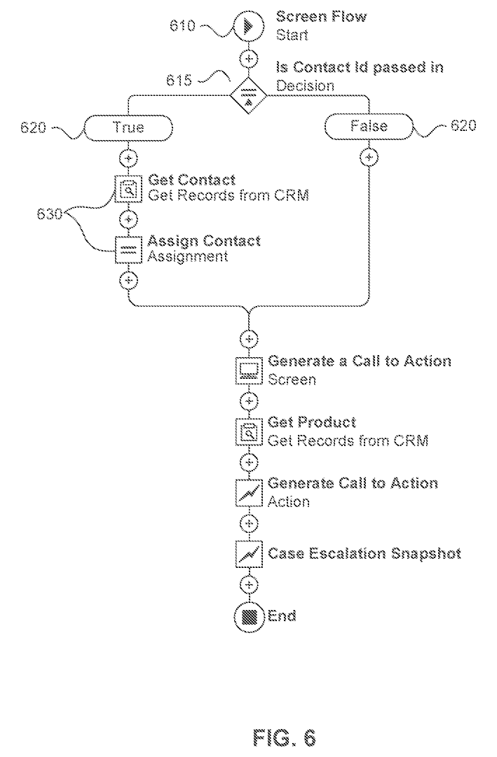

FIG. 6 illustrates an exemplary user interface 600 for use with proactive copilot method according to aspects of the present disclosure. As shown in FIG. 6, the UI includes a visual process flow 600 in which different functional elements of a given flow are displayed visually. In embodiments of the present disclosure, the process flow 600 is a visual representation of a flow to be carried out by a computing system. Because of its visual nature, users are able to “program” the process by adding visual elements to the flow 600.

For example, as shown in FIG. 6, the process flow 600 includes several visual process elements. These process elements can take a wide variety of different forms, such as a start element 610 that defines the start of the process flow, decision elements 620, action elements 630 (e.g., get contact, assign contact, etc.), as well as an end element that defines the end of the process flow.

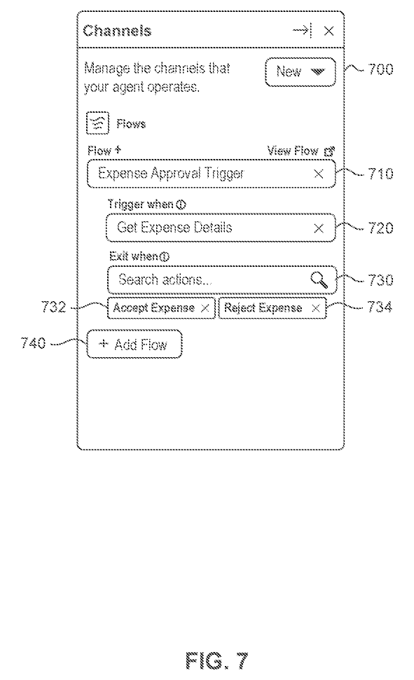

In the example UI of FIG. 6, the process flow 600 includes an action referred to as “generate a call to action.” When selected, an edit frame within the user interface displays the properties and several editable fields associated with that action element. FIG. 7 illustrates an example of at least one such display portion within the edit field, through which the user is able to edit or program an automatic recommendation to be monitored.

FIG. 7 illustrates an exemplary user interface 700 for programming an automatic recommended action to be monitored. As shown in FIG. 7, the user interface 700 includes a field 710 in which the user is able to provide a title associated with the monitored action. In the example of FIG. 7, the title is “Expense Approval Trigger” for an automated action recommendation relating to requesting reimbursement for certain business-related expenses.

In field 720, the user is able to define a triggering condition that triggers the recommended action. In embodiments, a plurality of different triggering conditions can be provided, and can be defined with “and” or “or” operators to make clear when one or all/multiple of the triggering conditions must be present. In the example of FIG. 7, the action is triggered when expense details are obtained.

In field 730 of FIG. 7, the user is able to define one or more exit conditions that define when the recommended action has been completed. In the example of FIG. 7, this may be when the expense reimbursement has been approved, or when a reimbursement has been received. As with the trigger field 720, multiple different exit conditions can be defined, as well as “and” or “or” operators. Fields 732 and 734 show exit conditions that have already been defined, including that the expense has been accepted (732) or that the expense has been rejected (734). Field 740 allows the user to add the action for monitoring the expense approval trigger to the flow of FIG. 6.

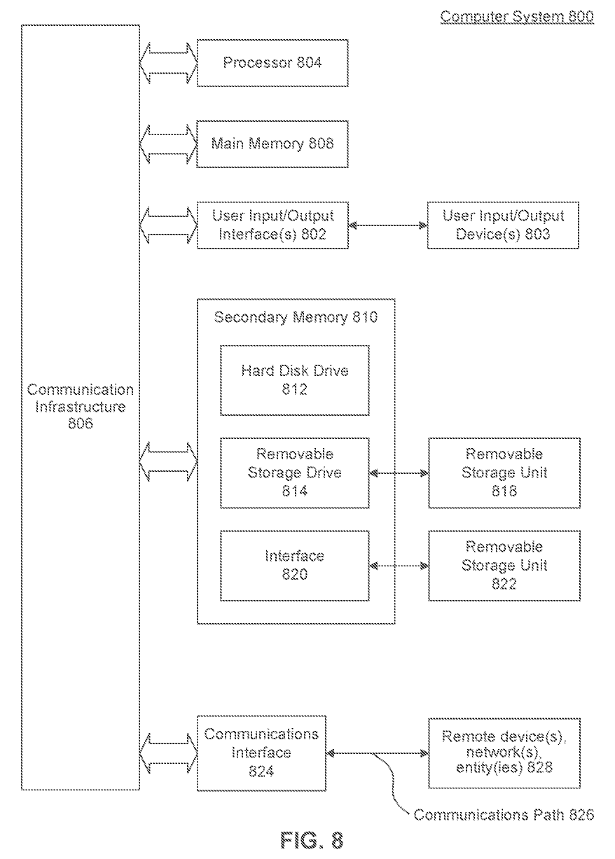

Various aspects may be implemented, for example, using one or more well-known computer systems, such as computer system 800 shown in FIG. 8. One or more computer systems 800 may be used, for example, to implement any of the aspects discussed herein, as well as combinations and sub-combinations thereof, including but not limited to the proactive copilot system 200, the AI model 230, among others.

Computer system 800 may include one or more processors (also called central processing units, or CPUs), such as a processor 804. Processor 804 may be connected to a communication infrastructure or bus 806.

Computer system 800 may also include customer input/output device(s) 803, such as monitors, keyboards, pointing devices, etc., which may communicate with communication infrastructure 806 through customer input/output interface(s) 802.

One or more of processors 804 may be a graphics processing unit (GPU). In an aspect, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include a main or primary memory 808, such as random-access memory (RAM). Main memory 808 may include one or more levels of cache. Main memory 808 may have stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 may include a computer usable or readable storage device having stored thereon computer software (control logic) and/or data. Removable storage unit 818 may be a floppy disk, magnetic tape, compact disk, DVD, optical storage disk, and/ any other computer data storage device. Removable storage drive 814 may read from and/or write to removable storage unit 818.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 may enable computer system 800 to communicate and interact with any combination of external devices, external networks, external entities, etc. (individually and collectively referenced by reference number 828). For example, communication interface 824 may allow computer system 800 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some aspects, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800), may cause such data processing devices to operate as described herein.

Based on the teachings included in this disclosure, it will be apparent to persons skilled in the relevant art(s) how to make and use aspects of this disclosure using data processing devices, computer systems and/or computer architectures other than that shown in FIG. 8. In particular, aspects can operate with software, hardware, and/or operating system implementations other than those described herein.

It is to be appreciated that the Detailed Description section, and not any other section, is intended to be used to interpret the claims. Other sections can set forth one or more but not all exemplary aspects as contemplated by the inventor(s), and thus, are not intended to limit this disclosure or the appended claims in any way.

While this disclosure describes exemplary aspects for exemplary fields and applications, it should be understood that the disclosure is not limited thereto. Other aspects and modifications thereto are possible, and are within the scope and spirit of this disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative aspects can perform functional blocks, steps, operations, methods, etc. using orderings different than those described herein.

References herein to “one aspect,” “an aspect,” “an example aspect,” or similar phrases, indicate that the aspect described can include a particular feature, structure, or characteristic, but every aspect can not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein. Additionally, some aspects can be described using the expression “coupled” and “connected” along with their derivatives. These terms are not necessarily intended as synonyms for each other. For example, some aspects can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary aspects, but should be defined only in accordance with the following claims and their equivalents.

What is claimed is:

1. A method for providing a recommended action in a workflow environment, comprising:
obtaining data from within the workflow environment relating to a user;
requesting, from a machine-learning model trained on previous user data and corresponding user actions taken with respect to the previous user data, a recommended action based on an analysis of the obtained data and a circumstance of at least one of the user or a customer of the user identified based on the analysis;
generating a user interface configured to provide the recommended action and a plurality of actionable buttons corresponding to different responsive actions with respect to the recommended action, the plurality of actionable buttons including an accept button; and
performing the recommended action responsive to selection of the accept button.

2. The method of claim 1, wherein the model trained on previous actions taken by a user within a company environment and a plurality of company guidelines.

3. The method of claim 1, wherein the plurality of buttons further include a take to chat button, the method further comprising, in response to the user selecting the take to chat button, provide the user with an interface to modify a request associated with the recommended action to be sent to the machine-learning model.

4. The method of claim 1, wherein the plurality of buttons further include a SEE DETAILS button, the method further comprising, in response to the user selecting the SEE DETAILS button, preliminarily execute the recommended action and provide results of the recommended action to the user in a user interface for review and editing.

5. The method of claim 1, wherein the machine-learning model is further configured to generate at least one of an urgency or an expiration date associated with the recommended action.

6. The method of claim 5, further comprising adding the recommended action to a list of recommended actions, ranked according to one of their urgencies or expiration dates.

7. The method of claim 1, wherein the user interface is a chat interface, within which the user is capable of providing text inputs and point-based selections.

8. A device for providing a recommended action in a workflow environment, comprising:
a memory that stores user data; and
one or more processors configured to:
obtain data from within the workflow environment relating to a user;
request, from a machine-learning model trained on previous user data and corresponding user actions taken with respect to the previous user data, a recommended action based on an analysis of the obtained data and a circumstance of at least one of the user or a customer of the user identified based on the analysis;
generate a user interface configured to provide the recommended action and a plurality of actionable buttons corresponding to different responsive actions with respect to the recommended action, the plurality of actionable buttons including an accept button; and
perform the recommended action responsive to selection of the accept button.

9. The device of claim 8, wherein the machine-learning model is trained on previous actions taken by a user within a company environment and a plurality of company guidelines.

10. The device of claim 8, wherein the plurality of buttons further includes a take to chat button, and
wherein the one or more processors are further configured to, in response to the user selecting the take to chat button, provide the user with an interface to modify a request associated with the recommended action to be sent to the machine-learning model.

11. The device of claim 8, wherein the plurality of buttons further include a SEE DETAILS button, and
wherein the one or more processors are further configured to, in response to the user selecting the SEE DETAILS button, preliminarily execute the recommended action and provide results of the recommended action to the user in a user interface for review and editing.

12. The device of claim 8, wherein the machine-learning model is further configured to generate at least one of an urgency or an expiration date associated with the recommended action.

13. The device of claim 12, wherein the one or more processors are further configured to add the recommended action to a list of recommended action, ranked according to one of their urgencies or expiration dates.

14. The device of claim 8, wherein the user interface is a chat interface, within which the user is capable of providing text inputs and point-based selections.

15. A non-transitory computer-readable storage medium having instructions stored thereon that, when executed by one or more processors of a computing device, cause the computing device to perform operations, comprising:
obtaining data relating to a user;
requesting, from a machine-learning model trained on previous user data and corresponding user actions taken with respect to the previous user data, a recommended action based on an analysis of the obtained data and a circumstance of at least one of the user or a customer of the user identified based on the analysis;
generating a user interface configured to provide the recommended action and a plurality of actionable buttons corresponding to different responsive actions with respect to the recommended action, the plurality of actionable buttons including an accept button; and
performing the recommended action responsive to selection of the accept button.

16. The non-transitory computer-readable storage medium of claim 15, wherein the model trained on previous actions taken by a user within a company environment and a plurality of company guidelines.

17. The non-transitory computer-readable storage medium of claim 15, wherein the plurality of buttons further include a take to chat button, and
wherein the operations further comprise, in response to the user selecting the take to chat button, providing the user with an interface to modify a request associated with the recommended action to be sent to the machine-learning model.

18. The non-transitory computer-readable storage medium of claim 15, wherein the plurality of buttons further include a SEE DETAILS button, and
wherein the operations further comprise, in response to the user selecting the SEE DETAILS button, preliminarily executing the recommended action and provide results of the recommended action to the user in a user interface for review and editing.

19. The non-transitory computer-readable storage medium of claim 15, wherein the machine-learning model is further configured to generate at least one of an urgency or an expiration date associated with the recommended action, and
wherein the operations further comprise adding the recommended action to a list of recommended actions, ranked according to one of their urgencies or expiration dates.

20. The non-transitory computer-readable storage medium of claim 15, wherein the user interface is a chat interface, within which the user is capable of providing text inputs and point-based selections.
